(19) United States
(12) Patent Application Publication
(10) Pub. No.: US 2019/0124856 A1
(43) Pub. Date: May 2, 2019

(54) EXCAVATOR ATTACHMENT APPARATUS WITH INTEGRATED POWER SAW

(71) Applicants: Jeffrey Lynn Hamilton, King, NC (US); Randy Keith Bowlin, King, NC (US)

(72) Inventors: Jeffrey Lynn Hamilton, King, NC (US); Randy Keith Bowlin, King, NC (US)

(21) Appl. No.: 16/175,886

(22) Filed: Oct. 31, 2018

Related U.S. Application Data
(60) Provisional application No. 62/579,363, filed on Oct. 31, 2017.

(51) Int. Cl. A01G 23/081; A01G 23/00; A01G 23/091; E02F 3/96

(52) U.S. Cl. CPC A01G 23/081; E02F 3/96; A01G 23/091; A01G 23/003

(57) ABSTRACT

An excavator attachment apparatus includes a first fork configured to be removably attached to the distal end of a dipper arm of an excavator, wherein the first fork has an inner side and an outer side. The excavator attachment apparatus further includes a power saw, wherein the proximal end of the power saw is rotatably coupled to the outer side of the first fork. The excavator attachment apparatus further includes a hydraulic cylinder configured to rotate the power saw when the hydraulic cylinder is actuated. The excavator attachment apparatus further includes a second fork configured to be removably attached to the bucket link and distal end of the dipper arm of the excavator and actuated by the hydraulic bucket cylinder of an excavator to alternate between an open position and a closed position relative to the first fork.

### CROSS-REFERENCE TO RELATED APPLICATIONS

This application claims priority to U.S. Provisional Patent Application No. 62/579,363 filed on Oct. 31, 2017, the entire content of which is hereby incorporated by reference.

### BACKGROUND

The present disclosure generally relates to an excavator attachment apparatus with an integrated power saw. Embodiments include an excavator attachment apparatus comprising a first grapple configured to be removably attached to the distal end of a dipper arm of an excavator, a second grapple configured to be removably attached to the bucket link of an excavator, a power saw integrated into the first grapple, and hydraulic components and links connected to the hydraulic pump of the excavator.

Clearing and disposing of felled trees is difficult and dangerous. Traditionally, the felled trees are cut by hand using chain saws into manageable pieces and then cleared from the site via manual labor. The traditional process poses many risks to workers. Operating chain saws is inherently dangerous with few options for mitigating injury in the event of an accident. Cutting trees with chain saws also results in high-speed flying debris which may result in injury as well. The weight of even smaller pieces of lumber can result in injury in the event of an accident.

Excavators are commonly used in construction and widely available. The cabins of excavators distance and insulate their operators from the dangers associated with operating heavy machinery. Excavators are also pre-equipped with hydraulic equipment necessary to efficiently and effortlessly move heavy items such as large trees.

Thus, there is a need for an excavator attachment apparatus that can cut and grasp large and heavy items using the hydraulic systems pre-equipped in excavators.

### SUMMARY OF THE INVENTION

The present invention relates to an excavator attachment apparatus configured to utilize hydraulic systems of an excavator to actuate a power saw and grasping mechanism. In preferred embodiments, the present invention, when attached to an excavator, may be used to cut and move felled trees or other large, heavy objects without placing workers at risk.

In one embodiment of the present invention, an excavator attachment apparatus may include a first fork configured to be removably attached to the distal end of a dipper arm of an excavator, wherein the first fork has an inner side and an outer side. The excavator attachment apparatus may further include a power saw, wherein the proximal end of the power saw is rotatably coupled to the outer side of the first fork. The excavator attachment apparatus may further include a hydraulic cylinder configured to rotate the power saw when the hydraulic cylinder is actuated. The excavator attachment apparatus may further include a second fork configured to be removably attached to the bucket link and distal end of the dipper arm of the excavator and actuated by the hydraulic bucket cylinder of an excavator to alternate between an open position and a closed position relative to the first fork.

In another embodiment of the present invention, an excavator attachment apparatus may include a first grapple. The first grapple may include a first connector at the proximal end configured to be removably attached to the distal end of a dipper arm of an excavator. The first grapple may further include a first fork at the distal end comprising at elast one prong, wherein the at least one prong has an inner side and an outer side. The first grapple may further include a plate disposed proximate the outer side of the first fork. The plate may have an offset circular member. The first grapple may further include a power saw, wherein the proximal end of the power saw is rotatably coupled to the circular member of the plate. The first grapple may further include a hydraulic cylinder having a first end and a second end, wherein the hydraulic cylinder is connected to a hydraulic fluid source, and wherein the first end is attached to the proximal end of the first grapple, and wherein the second end is coupled to the proximal end of the power saw such that actuating the hydraulic cylinder rotates the power saw about the circular member. The excavator attachment apparatus may further include a second grapple. The second grapple may include a second connector at the proximal end configured to be removably attached to the bucket link and distal end of the dipper arm of the excavator. The second grapple may further include a second fork at the distal end comprising at least one prong. The second grapple may be configured such that actuating the hydraulic bucket cylinder of the excavator causes the second grapple to alternate between an open position and closed position relative to the first grapple.

In yet another embodiment, in the closed position, the prongs of the first fork may interlace with the prongs of the second fork.

In yet another embodiment, the excavator attachment apparatus may further include at least one hydraulic link.

In yet another embodiment, the at least one hydraulic link may be configured to provide fluid communication between a hydraulic pump of an excavator and the hydraulic cylinder.

In yet another embodiment, the at least one hydraulic link is configured to provide fluid communication between the hydraulic pump of the excavator and the power saw.

In yet another embodiment, the excavator attachment apparatus may further include a fuel reserve configured to deliver fuel to the power saw.

In yet another embodiment, the excavator attachment apparatus may further include at least one fuel link.

In yet another embodiment, the fuel link may be configured to provide fluid communication between the fuel reserve and the power saw.

In yet another embodiment, the power saw is a hydraulic powered saw.

### BRIEF DESCRIPTION OF THE DRAWINGS

FIG. 1 is a side view of an excavator attachment apparatus attached to an excavator dipper arm according to an embodiment of the present invention.

FIG. 2 is an isometric view of an excavator attachment apparatus attached to an excavator dipper arm according to an embodiment of the present invention.

FIG. 3A is an isometric view of a first fork and power saw according to an embodiment of the present invention.

FIG. 3B is an isometric view of a first fork and power saw according to an embodiment of the present invention.

FIG. 4A is an isometric view of a second fork according to an embodiment of the present invention.

FIG. 4B is an isometric view of a second fork according to an embodiment of the present invention.

FIG. 5 is a schematic diagram of a first fork according to an embodiment of the present invention.

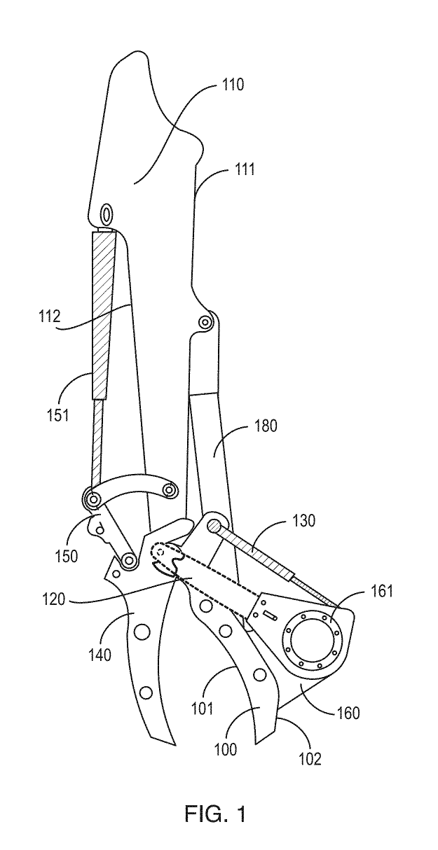

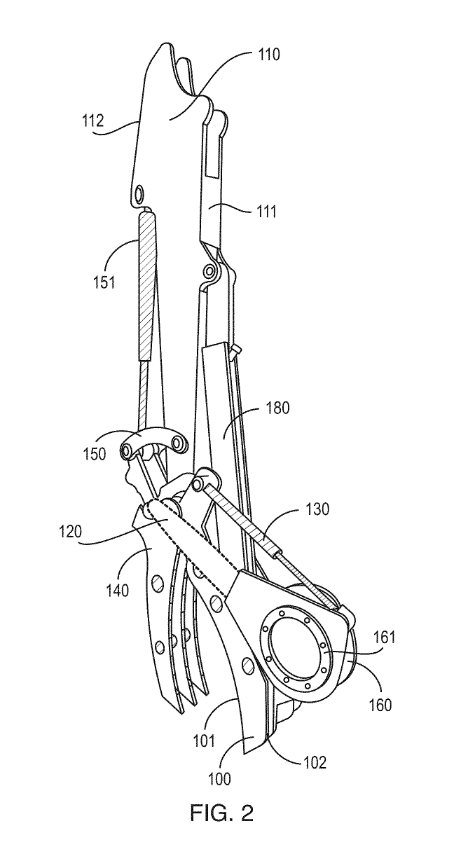

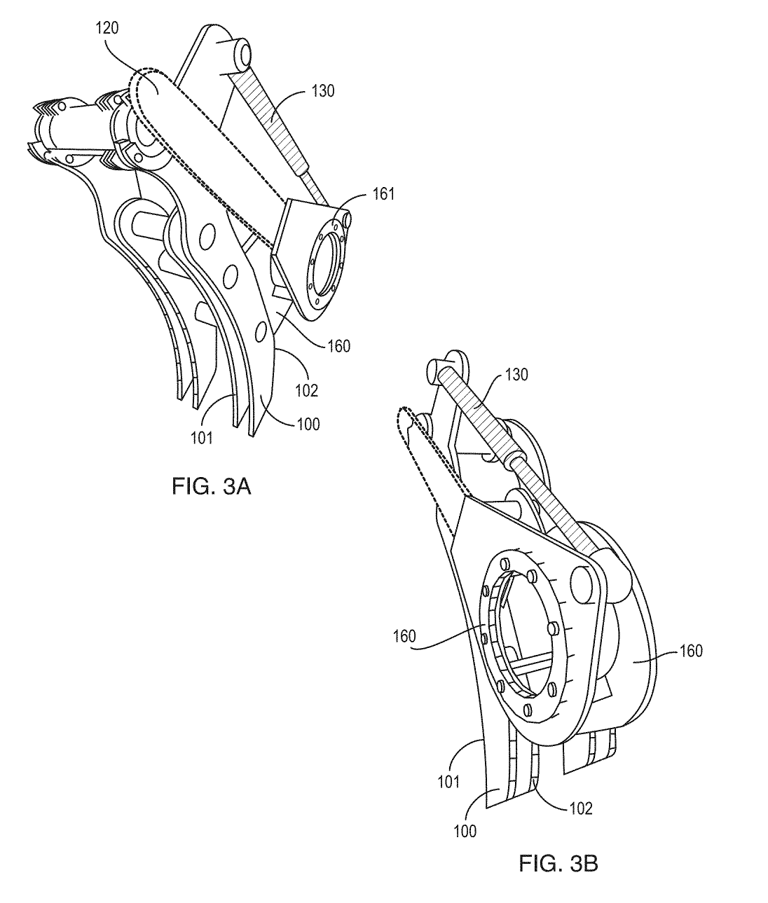

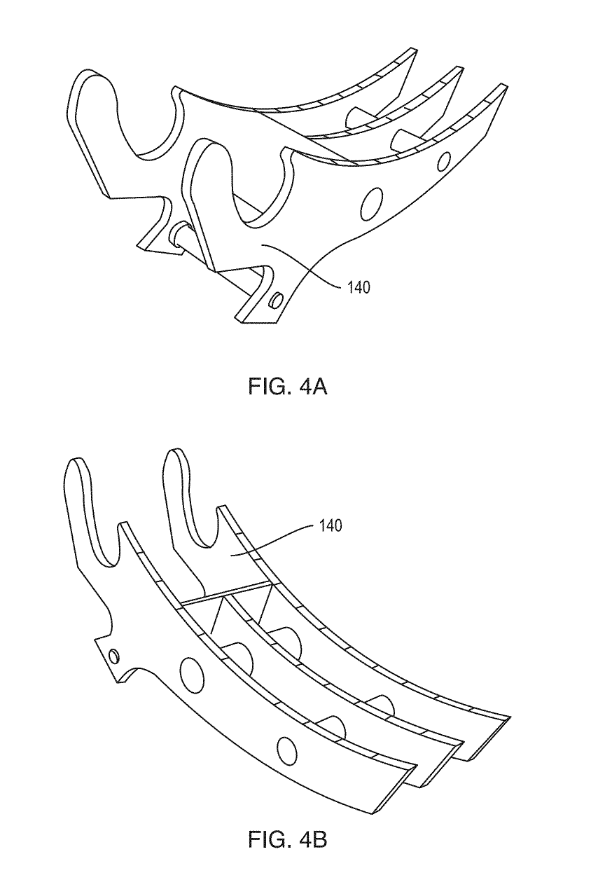

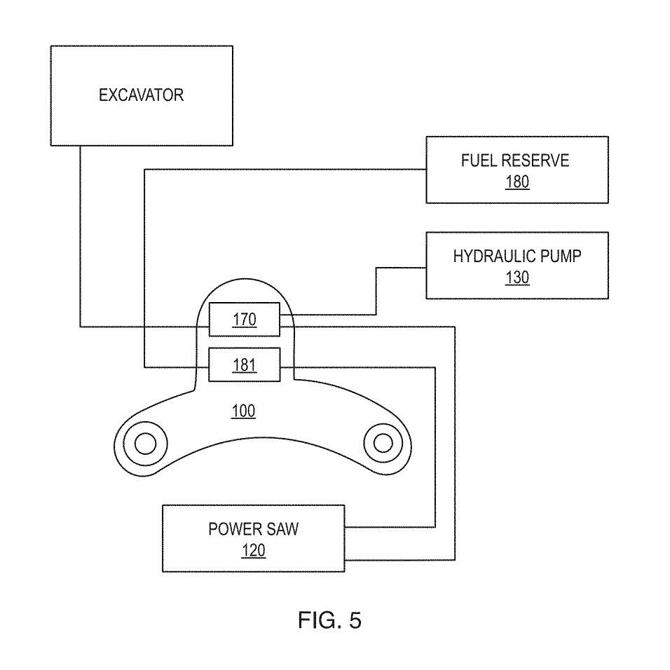

### DETAILED DESCRIPTION

In the following description, for the purposes of explanation, numerous specific details are set forth in order to provide a thorough understanding of the embodiments of the invention. One skilled in the art will recognize that the embodiments of the invention may be practiced without these specific details or with an equivalent arrangement. In other instances, well-known structures and devices are shown in block diagram form in order to avoid unnecessarily obscuring the embodiments of the invention.

The presently disclosed subject matter is presented with sufficient details to provide an understanding of one or more particular embodiments of broader inventive subject matters. The descriptions expound upon and exemplify particular features of those particular embodiments without limiting the inventive subject matters to the explicitly described embodiments and features. Considerations in view of these descriptions will likely give rise to additional and similar embodiments and features without departing from the scope of the presently disclosed subject matter.

According to one embodiment of the present invention, an excavator attachment apparatus may include a first fork 100 configured to be removably attached to the distal end of a dipper arm 110 of an excavator, wherein the first fork 100 has an inner side 101 and an outer side 102. The excavator attachment apparatus may further comprise a power saw 120, wherein the proximal end of the power saw is rotatably coupled to the outer side of the first fork 100. The excavator attachment apparatus may further include a hydraulic cylinder 130 configured to rotate the power saw 120 when the hydraulic cylinder 130 is actuated. The excavator attachment apparatus may further include a second fork 140 configured to be removably attached to the bucket link 150 of an excavator and actuated by the hydraulic bucket cylinder 151 of an excavator to alternate between an open position and a closed position relative to the first fork 100.

A dipper arm 110 of an excavator generally includes an outer side 112 and an inner side 111. A hydraulic bucket cylinder 151 and bucket link 150 are typically located on the outer side 112 of the dipper arm. Actuating the hydraulic bucket cylinder 151 causes the bucket link 150 to rotate attachments about the distal end of the dipper arm 110. The inner side 112 of the dipper arm 110 generally includes anchor points comprising holes through which attachments may be bolted. The first fork 100 may be attached to the distal end of the dipper arm 110 in a fixed position such that the outer side 102 of the first fork 100 faces towards the excavator cabin and the inner side 101 of the first fork 100 faces away from the excavator cabin. The proximal end of the power saw 120 may be rotatably coupled to the outer side 102 of the first fork 100.

In preferred embodiments, a plate 160 is disposed proximate the outer side 102 of the first fork 100 such that the plate is substantially parallel to the prongs of the first fork 100. The plate 160 may include a circular member 161 offset from the plate 160. The proximal end of the power saw 120 may be rotatably coupled to the circular member 161. In still yet preferred embodiments, a saw mount 121 comprising a ring configured to fit around the circular member 161 and configured to hold a power saw 120 may be coupled to the circular member 161.

A hydraulic cylinder 130 configured to rotate the power saw when the hydraulic cylinder 130 is actuated may be disposed on the outer side 102 of the first fork 100. One end of the hydraulic cylinder 130 may be attached to the first fork 100 near the attachment point with the distal end of the dipper arm 110. The other end of the hydraulic cylinder 130 may be coupled to the proximal end of the power saw 120. The hydraulic cylinder 130 may be connected to the pre-equipped hydraulic systems on the excavator such that the hydraulic cylinder 130 may be actuated from within the excavator cabin. Actuating the hydraulic cylinder 130 causes the power saw 120 to rotate around the circular member 161. In preferred embodiments, the power saw 120 is a hydraulic powered saw and connected to the hydraulic link 170. Actuating the hydraulic cylinder 130 causes the hydraulic powered saw to activate.

The second fork 140 may be attached to the distal end of the dipper arm 110 at the same point as the first fork 100. The bucket link 150 may be attached to an outer side 142 of the second fork 140. Actuating the hydraulic bucket cylinder 151 of the excavator causes the second fork 140 to rotate about the distal end of the dipper arm 110. The second fork 140 may be rotated into a closed position or an open position relative to the first fork 100.

In yet another embodiment, in the closed position, the prongs of the first fork 100 interlace with the prongs of the second fork 140. Thus, in the closed position, the excavator attachment apparatus may grasp objects between the first fork 100 and second fork 140.

In yet another embodiment, the excavator attachment apparatus may further comprise a hydraulic link 170. The hydraulic link 170 may be disposed on the plate 160 and configured to provide fluid communication between a hydraulic pump of the excavator and the hydraulic cylinder 130.

In yet another embodiment, the at least one hydraulic link 170 is configured to provide fluid communication between the hydraulic pump of the excavator and the power saw 120.

In yet another embodiment, the power saw 120 may be a hydraulic powered saw. The power saw 120 is connected to the hydraulic pump of the excavator via the at least one hydraulic link 170. The hydraulic pump drives both the hydraulic cylinder 130 and the hydraulic powered saw, such that when the hydraulic pump actuates the hydraulic cylinder 130, causing the hydraulic powered saw to rotate, the hydraulic powered saw is also activated.

In yet another embodiment, the excavator attachment apparatus may further comprise a fuel reserve 180 configured to deliver fuel to the power saw 120. The fuel reserve 180 may be coupled to anchor points on the inner side 111 of the dipper arm 110.

In yet another embodiment, the excavator attachment apparatus may comprise at least one fuel link 181. The fuel link 181 may be disposed on the plate 160 and configured to provide fluid communication between the fuel reserve 180 and the power saw 120.

In yet another embodiment, the excavator attachment apparatus may further comprise a safety cover (not pictured) configured to cover the saw when not in use. The safety cover may be attached to the circular member 161 such that actuating the hydraulic cylinder 130 to rotate the power saw 120 does not cause the safety cover to move.

In another embodiment of the present invention, an excavator attachment apparatus may include a first grapple. The first grapple may include a first connector at the proximal end configured to be removably attached to the distal end of a dipper arm of an excavator. The first grapple may include a first fork at the distal end comprising at least one prong, wherein the at least one prong has an inner side and an outer side. The grapple may further include a plate disposed proximate the outer side of the first fork, the plate having an offset circular member. The first grapple may further include a power saw, wherein the proximal end of the power saw is rotatably coupled to the circular member of the plate. The first grapple may include a hydraulic cylinder having a first end and second end. The hydraulic cylinder may be connected to a hydraulic fluid source. The first end of the hydraulic cylinder may be attached to the proximal end of the first grapple and the second end may be coupled to the proximal end of the power saw such that actuating the hydraulic cylinder rotates the power saw about the circular member. The excavator attachment apparatus may also include a second connector at the proximal end configured to be removably attached to the bucket link and distal end of the dipper arm of the excavator. The second grapple may include a second fork at the distal end comprising at least one prong. The second grapple may be configured such that actuating the hydraulic bucket cylinder of the excavator causes the second grapple to alternate between an open position and closed position relative to the first grapple.

The proximal end of the first grapple may be attached to the distal end of the dipper arm in a fixed position such that the outer side of the at least one prong faces towards the excavator cabin and the inner side of the at least one prong faces away from the excavator cabin. The proximal end of the power saw may be rotatably coupled to the circular member of the plate. In preferred embodiments, the circular members offset from the fork.

The hydraulic cylinder may be connected to the pre-equipped hydraulic systems on the excavator such that the hydraulic cylinder may be actuated from within the excavator cabin.

The second grapple may be attached to the distal end of the dipper arm at the same point as the first grapple. The bucket link may be attached to an outer side of the grapple. Actuating the hydraulic bucket cylinder of the excavator causes the second grapple to rotate about the distal end of the dipper arm. The second grapple may be rotated into a closed position or an open position relative to the first grapple.

The above description and drawings are illustrative and are not to be construed as limiting the invention to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the disclosure provided herein can be applied to other systems, not necessarily the system described above. The elements and acts of the various embodiments described above can be combined to provide further embodiments.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example reference to “an additive” can include a plurality of such additives, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments, +/−10%, in some embodiments +/−5%, in some embodiments +/−1%, in some embodiments +/−0.5%, and in some embodiments, +/−0.1%, from the specified amount, as such variations are appropriate in the disclosed products and methods.

1. An excavator attachment apparatus comprising:
a first fork configured to be removably attached to the distal end of a dipper arm of an excavator,
wherein the first fork has an inner side and an outer side;
a power saw, wherein the proximal end of the power saw is rotatably coupled to the outer side of the first fork;
a hydraulic cylinder configured to rotate the power saw when the hydraulic cylinder is actuated;
a second fork configured to be removably attached to the bucket link and distal end of the dipper arm of the excavator and actuated by the hydraulic bucket cylinder of an excavator to alternate between an open position and a closed position relative to the first fork.

2. The excavator attachment apparatus of claim 1, wherein, in the closed position, the prongs of the first fork interlace with the prongs of the second fork.

3. The excavator attachment apparatus of claim 1, further comprising at least one hydraulic link.

4. The excavator attachment apparatus of claim 3, wherein the at least one hydraulic link is configured to provide fluid communication between a hydraulic pump of the excavator and the hydraulic cylinder.

5. The excavator attachment apparatus of claim 4, wherein the at least one hydraulic link is configured to provide fluid communication between the hydraulic pump of the excavator and the power saw.

6. The excavator attachment apparatus of claim 1, further comprising a fuel reserve configured to deliver fuel to the power saw.

7. The excavator attachment apparatus of claim 5, further comprising at least one fuel link.

8. The excavator attachment apparatus of claim 1, wherein the at least one fuel link is configured to provide fluid communication between the fuel reserve and the power saw.

9. The excavator attachment apparatus of claim 5, wherein the power saw is a hydraulic powered saw.

10. An excavator attachment apparatus comprising:
a first grapple comprising:
a first connector at the proximal end configured to be removably attached to the distal end of a dipper arm of an excavator;
a first fork at the distal end comprising at least one prong, wherein the at least one prong has an inner side and an outer side;
a plate disposed proximate the outer side of the first fork, the plate having an offset circular member:
a power saw, wherein the proximal end of the power saw is rotatably coupled to the circular member of the plate;
a hydraulic cylinder having a first end and a second end,
wherein the hydraulic cylinder is connected to a hydraulic fluid source, and
wherein the first end is attached to the proximal end of the first grapple, and
wherein the second end is coupled to the proximal end of the power saw such that actuating the hydraulic cylinder rotates the power saw about the circular member;
a second grapple comprising:
a second connector at the proximal end configured to be removably attached to the bucket link and distal end of the dipper arm of the excavator;
a second fork at the distal end comprising at least one prong;
wherein the second grapple is configured such that actuating the hydraulic bucket cylinder of the excavator causes the second grapple to alternate between an open position and closed position relative to the first grapple.

11. The excavator attachment apparatus of claim 10, wherein, in the closed position, the at least one prong of the first fork interlaces with the at least one prong of the second fork.

12. The excavator attachment apparatus of claim 10, wherein the plate further comprises:
at least one hydraulic link.

13. The excavator attachment apparatus of claim 12, wherein the at least one hydraulic link is configured to provide fluid communication between a hydraulic pump of an excavator and the hydraulic cylinder.

14. The excavator attachment apparatus of claim 12, wherein the at least one hydraulic link is configured to provide fluid communication between the hydraulic pump of the excavator and the power saw.

15. The excavator attachment apparatus of claim 10, further comprising a fuel reserve configured to deliver fuel to the power saw.

16. The excavator attachment apparatus of claim 15, further comprising at least one fuel link.

17. The excavator attachment apparatus of claim 15, wherein the at least one fuel link is configured to provide fluid communication between the fuel reserve and the power saw.

18. The excavator attachment apparatus of claim 14, wherein the power saw is a hydraulic powered saw.
